(19) United States
(12) Patent Application Publication
(10) Pub. No.: US 2002/0065646 A1
(43) Pub. Date: May 30, 2002

(54) Embedded debug system using an auxiliary instruction queue

(76) Inventors: Arthur H. Waldie, Albuquerque, NM (US); Robert W. James, Albuquerque, NM (US); Edward Meinelt, Albuquerque, NM (US); Kou-Chuan Chang, Renton, WA (US); David Merrell, Albuquerque, NM (US)

Correspondence Address: CALFEE HALTER & GRISWOLD, LLP, 800 SUPERIOR AVENUE, SUITE 1400, CLEVELAND, OH, 44114, US

(21) Appl. No.: 09/850,357

(22) Filed: May 7, 2001

Related U.S. Application Data
(60) Provisional application No. 60/231,798, filed on Sep. 11, 2000.

(51) Int. Cl. G06F 9/455

(52) U.S. Cl. 703/26

(57) ABSTRACT

Apparatus embedded in a processor system comprises: an auxiliary instruction queue (IQ); and control circuits for governing the programming of registers of the auxiliary IQ with a set of instructions and for controlling insertion of the programmed instructions of the auxiliary IQ into an instruction execution stream of the processor system substantially without interrupting processing operations thereof. In another embodiment, the IQ is memory mapped to render it part of the memory space of the processor system and the control circuits govern the programming of the auxiliary IQ with a set of debug instructions accessed from a debug monitor program over the bus. In yet another embodiment, each storage register of the IQ is fabricated in the IC to survive an upset transient wherein a monitor circuit detects an onset of the upset transient and governs the control circuits to transfer data of selected registers of the processor system into the auxiliary IQ for storage during the upset transient. A method of protecting the integrated circuit (IC) processor system against an upset transient is also disclosed. In still another embodiment, the registers of the auxiliary IQ are configurable in the power-up mode to store a set of boot loader instructions which are accessible by the processor system.

This application claims priority from U.S. Provisional Application Ser. No. 60/231,798 filed Sep. 11, 2000.

### BACKGROUND OF THE INVENTION

The present invention is related to processor systems in general, and more specifically, to apparatus including an auxiliary instruction queue and associated control circuits embedded in a processor system to permit the programming and execution of sequences of instructions for debugging and other operations substantially without interruption of the instruction execution stream of the processor system.

In the past, debugging of processor systems was performed by programming debug software directly into read only memory (ROM) of the processor system and then executing it when testing or developing the processor system. Debug code could temporarily be added to the user or application memory of a processor product to give visibility to data and register contents in the system being developed, thereby allowing an operator to locate, isolate and repair a problem with an application program, for example. The processor system could be tested by attaching a logic analyzer coupled to the processor bus via external pining to detect an address or data combination of the processor being tested. A detection event from the analyzer could be made to cause a processor interrupt to be generated, thus forcing the processor system under test to execute the debug code which gave the operator visibility into the system. The operator would then use the logic analyzer to program the desired condition at which he or she wanted to cause the interrupt and allow visibility into the system. When the bug was found and fixed, the added debug code could be removed once again.

In this logic analyzer configuration, the user code was loaded with a ROM resident display program that dumped the contents of the processor registers when it was executed via an interrupt. After the register contents were displayed to a display device, like a conventional display terminal, for example, the display program would simply return to the user program being executed which would continue to execute the user code. Depending on the logic analyzer's capabilities, multiple dumps of registers could be generated with each run. As an example, if the analyzer was configured to generate a trigger for a predetermined address, then the analyzer would generate an interrupt to be handled whenever the processor accessed that memory address. One drawback with this method was that the processor system used up an interrupt, usually a non-maskable interrupt (NMI), which was needed elsewhere. In addition, this method used the processor system to perform the register data dump, and therefore impacted significantly the performance thereof. Further to impacting performance, the contents of memory was vulnerable to change, since the processor system used a resident display program in memory to output data. Still further, the input/output (I/O) and interrupt assignments for debugging the system could not be used for user applications. Needless to say, debugging software was difficult at best using these debugging techniques.

More recently, as a result of much larger and more complex application programs, more sophisticated debugging tools have evolved to allow operators to monitor data, system registers and timing set contents within the program. For example, complete ROM-based debugger program applications typically co-exist with the end-application software on a given target integrated circuit (IC) processor system and provide a command interface for performing simple tasks on the target system such as reading and writing to system memory, inspecting processor registers and setting and clearing breakpoints. Quite often, a serial communication port, such as an universal asynchronous receive transmit (UART) interface, for example, is used to communicate data between an embedded debugger program and a host computer on which the debug software is compiled and generated. In the early 1970's, processor manufacturers started adding special instructions such as the SWI (software interrupt) instruction(s). These instructions gave the memory resident debug monitors the ability to interrupt program flow and restart it after allowing access to the processor registers at various points in a program for viewing and altering the contents thereof. This removed the need for having a logic analyzer attached to the system and worked well so long as the code being developed was located in memory that could be altered by swapping the existing instructions out with the SWI instruction. This method is still one of the most widely used debug techniques.

With the advent of On-Chip Debugging (OCD), a compliment of debugging hardware was embedded onto a processor IC or chip. Typically, these types of systems offered communication with a host computer by way of a JTAG (Joint Test Action Group) interface, which is an IEEE standard developed specifically to aid in hardware and software debugging with emphasis on manufacturing tests such as locating shorted pins or unsoldered pins, for example. The JTAG interface provides a method whereby a host computer can scan a serial data bit stream into one of a set of serially strung storage elements inside a component, such as a processor IC. These so-called “scan chains” allow the host system to scan out the binary values of each designated element of the processor in the scan chain and scan in new binary values for those same elements. A special scan chain, called boundary scan, connects the external pins of the processor IC together in a chain. Some debugging approaches have the JTAG interface read from and write to memory and communicate with a debug monitor resident therein via this boundary scan chain system. This method is very slow because the JTAG must scan all the pins multiple times in order to generate sequences that cause reads or writes of memory external the processor IC.

These scan chain debugging type systems can use various internal scan chains to directly inspect and load internal processor registers, as well as modify control storage elements to effect memory read and write operations. These systems can read and write memory, set breakpoints and watchpoints and run or halt the processor. One drawback of this type of system is that the clock, used to serially shift data through the scan chains, takes over as the processor clock during scan operations. So, during the scan operation, the processor effectively stops since the scan chain clock is slow relative to the normal processor clock. The scan chain clock speed and the length of the scan chains limit the speed at which these operations can be performed. Using the scan chain clock for the processor clock during scanning operations can be a problem for a target memory system that requires refresh, such as one that uses high density dynamic random access memories or DRAMs. If the processor slows down sufficiently during debugging operations, the DRAMs may not get refreshed as required and possibly lose the contents of its registers as a result. Also, this scan chain type of interface needs fundamental knowledge on the location of specific storage elements in the control and data structures of the processor architecture, e.g. all of the bit locations inside the scan chains within the processor IC. This does not lend itself to the level of abstraction that makes for simple modification and enhancement of the debugging system. Quite often a monitor program is embedded in the target computer to provide more flexibility. Even with this level of sophistication setting breakpoints, watchpoints and single stepping requires that the debug system place an instruction in target memory to trap out to the monitor program. Software engineers must work within these constraints to perform software development.

To improve the speed of the scan chain type debug systems, processor IC manufacturers embedded code, known as debug monitors, in sections of memory on the chip that would perform debug operations such as reading/writing registers and memory. This debug monitor code could be executed by a simple command issued from the JTAG interface, for example. The code of the debug monitors could be initiated quicker since the external boundary scan chain does not have to be used. These embedded debug monitor systems may use an internal or external temporary scratch pad area for storage of test data. Communications between the processor and the JTAG system is accomplished using the boundary scan chain or through special registers visible to the embedded monitor code. In both cases, these scan chains are usually very long and take significant time to complete each scan transfer. Also, even though the processor is able to execute the debug code at a higher speed and communicate at a higher rate to the host, it requires special communication registers to do so. In addition, when execution of the debug monitor code is initiated, the processor is interrupted and the virtual process in progress is preserved. This process is sometimes quite complex depending on the process being interrupted. Thereafter, the debug monitor is executed until complete, then the virtual process that was executing prior to the initiation of the debug monitor is restored and continues.

While this system does offer faster communication to/from the host and gives some limited debugging, it is not easily expandable since the embedded debug monitor is conventionally located in a ROM system on the processor IC. If it is necessary to add functionality to the embedded debug monitor code, the additional monitor functions are loaded into programmable read only memory (PROM) or random access memory (RAM) areas. During execution of the debug monitor, processor execution time or throughput is significantly impacted since the monitor is executed constantly using interrupts or signaling from the host which directs the debug operations. In some cases, the embedded monitor code is not visible to the user code and offers no lift to the user program. Another drawback found in these debug systems is that most implementations use hardware, like a local debug ROM, for example, that will remain embedded in the processor IC after delivery. This embedded circuitry will not be used in normal processor operations and does not offer any advantages when not performing debug functions. Accordingly, when debugging is not used, this extra hardware is not used and thereby lowers the reliability of the overall processor without adding any value.

While the present debug systems are adequate for testing and development of processor systems and the software programs therefor, there is always room for improvement. The present invention offers a system which overcomes the aforementioned drawbacks of the present debug systems and at the same time provides added value to the overall target processor system.

### SUMMARY OF THE INVENTION

In accordance with one aspect of the present invention, apparatus embedded in a processor system comprises: an auxiliary instruction queue (IQ) including a plurality of storage registers programmable with a set of instructions; and control means for governing the programming of the auxiliary IQ with the set of instructions and for controlling insertion of the programmed instructions of the auxiliary IQ into an instruction execution stream of the processor system substantially without interrupting processing operations thereof.

In accordance with another aspect of the present invention, debug apparatus embedded in a processor system that has a debug monitor program stored in a program memory thereof comprises: an auxiliary instruction queue (IQ) including a plurality of storage registers programmable with a set of debug instructions, the auxiliary IQ being coupled to a bus of the processor system, the storage registers being memory mapped to render the auxiliary IQ part of the memory space of the processor system; and control means for governing the programming of the auxiliary IQ with the set of debug instructions accessed from the debug monitor program over the bus and for controlling insertion of the programmed debug instructions of the auxiliary IQ into an instruction execution stream of the processor system substantially without interrupting processing operations thereof.

In yet another aspect of the present invention, protection apparatus embedded in an integrated circuit (IC) processor system comprises: an auxiliary data queue (DQ) including a plurality of storage registers for temporary storage of data, each storage register being fabricated in the IC to survive an upset transient, the auxiliary DQ being coupled to a bus of the processor system, the storage registers being memory mapped to render the auxiliary DQ part of the memory space of the processor system; and monitor means for detecting an onset of the upset transient; and control means governed by the monitor means for transferring data of selected registers of the processor system into registers of the auxiliary DQ for storage during said upset transient.

In still another aspect of the present invention, a method of protecting an integrated circuit (IC) processor system against an upset transient comprises the steps of: detecting an onset of the upset transient; transferring data of selected registers of the processor system into upset transient survivable registers of an auxiliary data queue (DQ) upon the detected onset; and storing the data in the registers of the auxiliary DQ during the upset transient.

In still another aspect of the present invention, auxiliary boot loader apparatus embedded in a processor system and operable in a power-up mode of said processor system comprises: an auxiliary instruction queue (IQ) including a plurality of storage registers configurable in the power-up mode to store a set of boot loader instructions, the registers of the auxiliary IQ being accessible by the processor system; and means for detecting the power-up mode and causing the processor system to access and execute the stored instructions of said auxiliary IQ.

### BRIEF DESCRIPTION OF THE DRAWINGS

FIG. 1 is a block diagram schematic of a processor system suitable for embodying the present invention.

FIG. 2 is a block diagram schematic of an exemplary debug system suitable for use in the embodiment of FIG. 1.

FIG. 2A is a schematic of a circuit embodiment suitable for operating the event detectors of the embodiment of FIG. 2.

FIG. 3 is a table delineating four exemplary modes of operation of the debug system.

FIG. 4 is a block diagram schematic of an instruction queue embodiment suitable for use in the debug system of FIG. 2.

FIG. 5 is a block diagram schematic of an event detector suitable for use in the debug system embodiment of FIG. 2.

FIG. 6 is a table exemplifying the states of the debug control register of the embodiment of FIG. 2.

FIG. 7 is a table exemplifying the states of the fault register of the embodiment of FIG. 2.

FIG. 8 is a table exemplifying the user mode accesses of the debug system registers of the embodiment of FIG. 2.

FIGS. 9A-9D are time waveforms exemplifying the relationship between JTAG control lines for normal boot operations of the processor system.

FIGS. 10A-10D are time waveforms exemplifying the relationship between JTAG control lines for serial boot operations of the processor system.

FIG. 11 is a table exemplifying a definition of the control bits of the debug instruction register of the embodiment of FIG. 2.

FIG. 12 is a block diagram schematic of an alternate embodiment of the processor system.

### DETAILED DESCRIPTION OF THE INVENTION

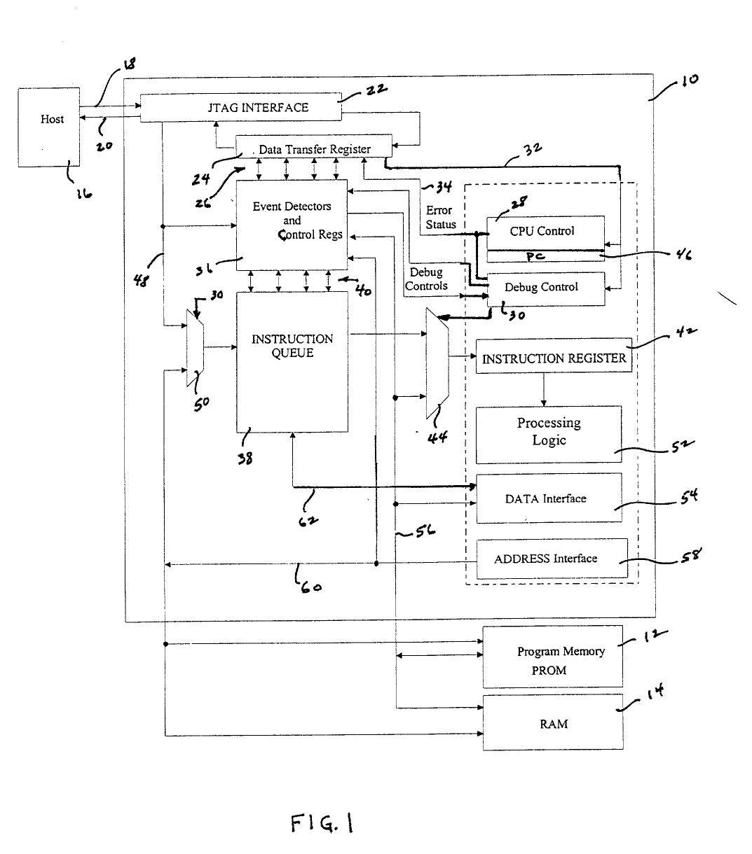

A block diagram schematic of a processor system suitable for embodying the principles of one aspect of the present invention is shown in FIG. 1. Referring to FIG. 1, a processor IC 10 is shown enclosed within a solid line. Beyond the core components shown enclosed within dashed lines, the processor system includes a program memory 12 which may be a programmable read only memory (PROM) and a random access memory (RAM) portion 14, for example. While the memories 12 and 14 are shown external to the processor IC 10, in some systems these memories or portions thereof may be embedded on the processor IC with the core components thereof. In the present embodiment, the processor system includes a debug system that is also embedded within the processor IC 10. This debug system allows a host device 16, such as a computer, for example, to communicate with the processor IC 10 over a serial bus depicted by signal lines 18 and 20 to transfer data and instructions to be executed by the processor 10 and receive data and status information resulting from the execution thereof. In the present embodiment, the debug system resides on the processor IC and is controlled by a debug controller within the core processing elements as will become more evident from the description herein below.

Also, in the present embodiment, the host computer 16 reads and writes data and instructions to the debug system by way of a conventional JTAG interface 22 via a data transfer register 24, for example. The debug system is accessed using the conventional JTAG system with the designated register locations defined by the JTAG instruction register 24. Data transfers to/from the embedded debug system are performed using a single short scan chain that may be on the order of forty bits long, i.e. thirty-two bits for data, seven bits for control and one bit for status, for example. The forty bit long data word is buffered in the register 24 which has bidirectional outputs 26 coupled to various working registers of the debug system of the processor IC 10. For example, the control bits which indicate what state and action the processor is to be in and perform once the data has been transferred between the host and the designated processor register are coupled to a CPU controller 28 and a debug controller 30 over signal lines 32. In the present embodiment, these control bits over lines 32 include such states and commands as JTAG Installed Mode, Enable JTAG debug mode, Enable Interrupts, Hold watch dog timer, Run CPU, Execute instruction queue (IQ), and Single step, for example. A more detailed understanding of these control lines is provided herein below. The status bit which is used for error indications and will be discussed later is coupled to the CPU and debug controllers, 28 and 30, respectively, over signal line 34.

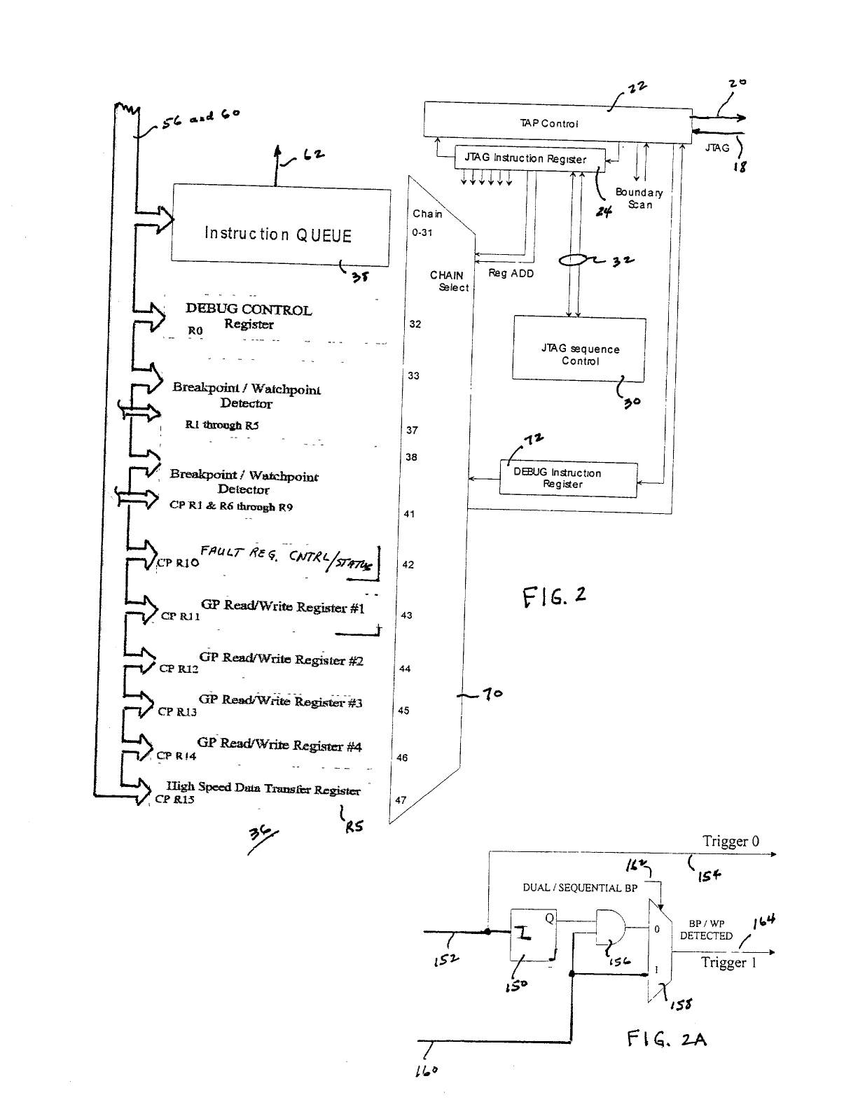

As will become more evident from the description below in regard to FIG. 2, the debug system includes a plurality of registers 36 for temporary and working data storage and event detection. Two of the registers (not shown) may be designated for data and address information for host-target transfers. Instead of forcing transfers to occur by manipulating scan chains around the boundary of the processor or CPU core elements within the IC, the present embodiment includes an auxiliary Instruction Queue (IQ) 38 which takes advantage of the inherent capabilities of the processor for debugging the processor system among other operations. In the present embodiment, the auxiliary IQ 38 comprises a plurality of registers, which may be on the order of thirty-two, for example, that are connected to registers 36 of the debug system over bidirectional lines 40 and is configured to allow it to access and provide instructions programmed therein automatically in a predetermined order into a processor instruction register 42 via a selector gate 44 without an address pointer, that is without interrupting the instruction execution stream of the processor system. When accessing the auxiliary IQ 38, the program counter (PC) 46 of the CPU 28 is controlled, preferably in temporary suspension, for example, and does not increment or point to instructions in the IQ thereby allowing processor instruction execution to resume immediately after execution of the instructions programmed into the auxiliary IQ 38. Moreover, the PC 46 may be loaded with an address utilizing the IQ which may divert the user program flow to a memory location at the end of execution of the IQ instructions that is different from the memory location loaded in the PC at the commencement of IQ instruction execution.

Further, signal lines 48 couple the JTAG interface 22 to the registers 36 and a selector gate 50, which is coupled to the auxiliary IQ 38, for carrying address information between the JTAG interface and the various registers of the debug system. And, other components of the processor IC core may include processing logic 52 coupled to the instruction register 42 for handling conventionally the processing operations thereof, a data interface 54 for communicating data over a processor data bus 56 which is coupled to various components of the processor system including the debug registers 36, the selector gate 44 which is coupled to the instruction register 42, and the memories 12 and 14, for example; and, an address interface 58 for communicating address information over a processor address bus 60 which is also coupled to various components of the processor system including the selector gate 50, the debug registers 36, and the memories 12 and 14, for example. Separate data lines 62 are coupled between the auxiliary IQ 38 and data interface 54.

In operation, the host computer 16, without interruption of processor operation, i.e. in the background, initializes registers 36 of the debug system with address and data information, and/or programs or loads the registers of the auxiliary IQ 38 with a set or sequence of native processor instructions, via the JTAG interface 22 and data transfer register 24, debug controller 30, and address lines 48 via selector gate 50 which is controlled by the debug controller 30, and then commands the auxiliary IQ 38 to execute utilizing the control lines 32, debug controller 30, and selector gate 44 which is controlled by the controller 30. Upon command, the instruction sequence of the auxiliary IQ 38 is automatically accessed and inserted into the instruction pipeline of the CPU at a rate commensurate with the processor clock and executed by the CPU controller 28 of the processor core. Thereafter, user program resumes as it left off without interruption of the instruction execution stream. During execution of the IQ sequence, the program counter 46 is not incremented, thereby preserving the state of the current user program being executed. The resulting data from the execution of the IQ instruction sequence may be stored in the working registers 36. Then, in the background, the host computer 16 may proceed with the operation of recovering the resulting data in the working registers 36 and the status information using conventional scan chain communication techniques. The instruction sequences programmed into the auxiliary IQ 38 when executed can perform any task that the user software can and accordingly, no embedded debug on-board software is required. In fact, for the present embodiment, an external target memory system is not required either.

Aside from performing debug operations, the auxiliary IQ 38 may also be programmed with an instruction sequence to perform other operations, like memory load operations, for example, as well. For a memory load operation to occur, the host computer 16 loads an appropriate instruction sequence into the auxiliary IQ 38 of the processor, initializes the designated debug coprocessor address register, and then begins loading one or more of the working data registers 36 of the debug system with data that is to be transferred to the memory 12 and/or 14 of the processor IQ 10. Each time one or more working data register(s) is (are) loaded with data, using the 40-bit scan chain, for example, the associated control bits over lines 32 command the debug controller 30 to initiate execution of the instruction sequence of the IQ. For example, the auxiliary IQ sequence (program) when executed may copy the data from a designated debug data register to the memory address location identified in another debug register. It may then increment the address of the debug register to the next memory location in which data is to be loaded and then, return execution to the user application program. The completion of the IQ execution may set the status bit over line 34 in the 40-bit scan chain that the host computer is scanning which tells the external host system if the IQ finished execution without an error or had an error during execution. The host may continue to scan in data to the one or more working data register(s) of the debug system and repeat the foregoing described process for each data load. The status bit is checked each time to insure that all data is written properly. With this approach, a 32-bit data word can be loaded to memory in the time it takes to scan 40 bits into the JTAG interface. This provides for fast downloads and uploads of target memory.

A set of instructions for automatic memory fill operations may be also programmed into the auxiliary IQ 38. In this example, the host system 16 may program the IQ 38 with the appropriate instruction sequence and may load a predetermined count into an on-chip counter, located in the debug coprocessor, for example. The instruction sequence of the IQ 38 may be then executed repetitiously for as many counts as are programmed into the counter, say up to 128 times, for example, without further host intervention. Accordingly, one forty-bit scan can cause 128 memory locations to be loaded once the appropriate IQ instruction sequence is programmed and predetermined count loaded.

In summary, it is noted that the processor system is never halted during the foregoing described operations. The processor continues to run its user or application software while the programmed instruction sequences of the auxiliary IQ are seamlessly inserted into the instruction execution stream. Another feature of the debug system worth noting is that the processor continues to run on its system clock, not the JTAG clock. This is important in that the processor clock signal is not a gated clock as it is for a system that switches between the processor clock and the JTAG clock. Still another feature is that the auxiliary IQ is capable of examining anything that processor software can have access to including coprocessors. Yet another aspect is that debugging functions can be added to the host system simply by writing new IQ instruction sequences. No modification of the processor hardware or embedded code is required. Finally, by having the debug and other instruction sequences located in the host computer, multiple configurations of the hardware can be made without requiring changes to the debug coprocessor. This provides debug capability extending to future designs.

More specifically, a block diagram schematic of an exemplary debug system suitable for use in the present embodiment is shown in FIG. 2. This system allows access to other systems within the processor IC and external systems. In addition, the debug system allows access by both standard debug methods which use ROM based monitors as well as using the JTAG type interface, e.g. lines 18 and 20. When the JTAG interface is used in the debug mode, it will not significantly impact the operation of the processor IC unless it is functionally commanded to do so via control bits over lines 32. The debug system does not use the boundary scan chain to perform debug functions and operates asynchronously with the processor system without changing clock timing parameters. When the processor is commanded to halt using the debug system, the processor external clock systems shall continue to operate to allow for dynamic refreshing of external dynamic memory systems. The functionality of the debug interface may be extended to allow operational (non-debug) functionality where possible.

Referring to FIG. 2, the exemplary processor IC 10 embodies a debug system including the Joint Test Action Group (JTAG) interface 22 and data transfer register 24, debug registers 36, debug controller 30, the auxiliary IQ 38, and a scan chain 70 coupling the JTAG interface 22 via register 24 with the debug registers 36 and registers of the auxiliary IQ 38. Primary functions within the debug block 36 include Control, Break Point/Watchpoint systems, transfer registers, trace buffer, for example. In the present embodiment, the debug registers 36 include two breakpoint/watchpoint register groups R1-R5 and R1, R6-R9, a fault register R10 for control/status storage, five general purpose 32-bit registers R11 through R15 (one R15 being used for high speed transfers), one DEBUG instruction register R0, and one JTAG instruction register 72. All of the debug registers 36 are coupled to the JTAG interface 22 via scan chain 70 and/or register 24. In addition, all of these registers with the exception of the JTAG instruction register 72 are visible by processor software through the processor bus including signal lines 56 and 60 and data and address interfaces 54 and 58, respectively. In the present embodiment, the auxiliary IQ 38, which includes thirty-two bit word registers, is coupled to the JTAG interface 22 via register 24 and/or scan chain 70, and is also visible to the processor software via buses 56 and 60 using registers which are memory mapped to the memory space of the processor. The JTAG instruction register 72 may be modified through the JTAG interface with certain bits visible to processor software through the control register R0.

In the present embodiment, the debug system is defined to allow logic analysis functionality offering break point and watch point capability, improved communications between external JTAG monitors and/or internal monitor/debug programs. For this purpose, the system has a plurality of basic functions that allow it to execute Debug operations including a first function which comprises the control register R0 that is used by the debug system to program the functionality of the debug system, a second function which allows the debug system to detect when events occur as defined by addresses, data and processor status states, this second function allowing the processor to generate either break point or watch point trigger signals depending on the mode of operation of the debug interface, and a third function comprising five 32-bit general purpose data registers R11-R15 which are configured to allow transfer of data/commands between the target processor system and the host device 16 via the JTAG interface 22.

Also, in the present embodiment, the auxiliary IQ 38 comprises up to thirty two 32-bit registers that can be used to store instructions that can be executed when commanded from the debug instruction register 72 or when the control register R0 forces execution. Execution of the instructions of the IQ 38 may also be triggered by event detector 0 including registers R1-R5 depending on the configuration of the register R0. As has been described supra, this function allows the processor to insert special instructions into the instruction pipeline of the processor directly and at high speed with minimal impact on the processor's performance. Control of the IQ 38 is dependent on special flags that control its execution which may be located in fault status and control register R10.

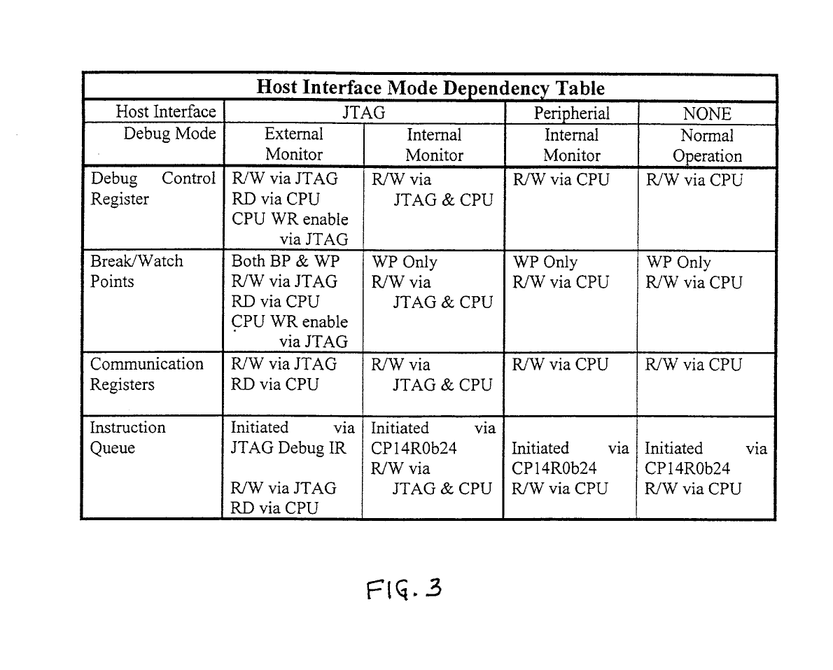

The plurality of functions defined above operate differently depending on the mode in which the target processor is configured. Four exemplary modes for performing debug operations on the processor are delineated in the table of FIG. 3 and further described as follows:

1. In this mode, all debug functions are commanded through the JTAG interface via the host 16 wherein a debug monitor is resident in the host (External Monitor Mode). This method allows the embedded debug circuitry to be armed and set to allow both breakpoint (B/P) and watchpoint (W/P) operations. The data transfer registers R10-R15 are used in this mode to move data to/from the processor in the background using the JTAG scan chain 70 and the IQ 38 is used to store instructions from the JTAG interface and then, execute them via a command issued by the debug Instruction register 72.

2. In this mode, a debug monitor is resident in ROM on the target processor IC 10 and communicates to the host computer 16 through the JTAG interface 22 (Internal Monitor Mode). Moreover, a hardware breakpoint may be disabled, but the watchpoint circuitry is allowed to cause interrupts to be generated to the resident debug monitor. The general purpose registers R10-R15 are used to communicate between the host and target processor system.

3. In this mode, all communication to/from the JTAG interface is disabled and breakpoint or instruction queuing is not permitted through the JTAG interface. (Peripheral Internal Monitor Mode). However, watchpoint capability is enabled. The General purpose registers R11-R15 may be used for data storage for the IQ 38, as needed, or for a debug operation.

4. In this mode, conventional non-debug operations are allowed (Normal Operation Mode). This mode allows the watchpoint operation of the event detector circuits and the generation of external trigger signals and interrupts (if enabled) whenever a programmed event occurs. The processor software is allowed to configure the detectors and debug system to perform these functions without the use of JTAG and while not in debug mode.

The mode settings may be defined by using a combination of bits from the JTAG and debug Instruction registers 24 and 72, respectively, as well as bits in the debug control register R0. The connection of the JTAG interface 22 to the processor system may be defined by the host writing a “JTAG installed bit”, bit 6, for example, into the JTAG instruction register 24, the status of which being then made available to the processor software through the debug control register R0, bit B2. Moreover, as shown by the exemplary embodiment of FIG. 2, the debug system uses standard processor read & write instructions from the processor core when accessed by the processor. The registers shown in the embodiment of FIG. 2 may also be accessed using the JTAG interface without impacting the throughput or requiring the processor to halt.

More specifically, each breakpoint/watchpoint group of registers (R1-R5) and (R1, R6-R9) comprise four 32-bit registers and a shared 32-bit register (R1) implemented as two 16-bit control registers. The registers are 1.) address register, 2.) data register, 3.) control register, 4.) address mask register and 5.) a data mask register. These sets of registers are used to define the event conditions on which to activate a detection signal that will be used to drive the external trigger, force execution of the IQ as well as cause an interrupt or halt the processor depending on the debug system configuration. In the present embodiment, interrupts may not be serviced during execution of the instructions of the IQ 38. These event detectors will be described in greater detail herein below in connection with the exemplary embodiment depicted in FIG. 5.

The thirty-two register auxiliary IQ 38, which is exemplified in greater detail in the block diagram schematic embodiment of FIG. 4, is comprised of 32-bit registers that are memory mapped within the memory space of the processor system. These registers IR0 through IR31 may be read by or written to by the JTAG interface via the scan chain 70 as well as by the processor core via the bus signals 56, 60 and 62. The JTAG interface 22 uses IQ 38 to hold instruction sequences that perform special debug operations which may include moving data to/from the debug scanable registers R11-R15, for example. When debugging is not being performed, the IQ 38 may be used by processor software to perform special non-debug functions such as installing a ROM patch or executing virtual functions, for example. Valid instructions in the IQ 38 may be characterized or identified by bits located in one of the registers of the IQ 38, say register IR 31, for example, which is called the instruction qualifier register (IQR). There is a one to one correspondence between the IQR bits and the instructions in the IQ 38. Once commanded to execute, the IQ 38 may automatically access and insert instructions from the registers thereof in a predetermined order, preferably sequential, into a processor pipeline 80 up to and including the first instruction flagged by a “0” state, for example, in the corresponding IQR bit position. In the present embodiment, a register selector circuit 82 coupled to the outputs of the registers IR0-IR31 is governed by address selection lines 84, the code of which may be derived from an instruction read out counter (not shown), for example, to access and insert the instructions from the IQ 38 into the pipeline 80 of the processor for execution thereby. When not in debug mode, the processor may be able to execute directly from the memory mapped registers of the IQ 38 allowing up to 32 instructions to be executed in the present embodiment. In addition, the IQ 38 may be initialized during power up with a serial boot loader that will allow the processor to load code via a serial communication port which will become more evident from the description provided herein below.

When operating in JTAG debug mode, the condition of a control bit in the debug instruction register 72, referred to as “Execute Instruction Queue” being set to “1” when the “Run CPU” bit is also set to “1” will initiate the insertion of instructions into the CPU pipeline 80. The IQ 38 may also be executed by processor software by setting the “Execute Debug Instruction Queue” bit, i.e. bit 24, of the control register R0 which is protected from software write during JTAG debug mode. Also, prior to permitting instruction insertion into the processor pipeline 80, the pipeline 80 is flushed. Immediately following the flush, an automatic transfer of the instructions from the IQ 38 is triggered, preferably sequentially, starting at register IR0 as described above.

The debug event state detectors in block 36 of the debug system are embedded into the processor IC 10 to monitor the state of the virtual address bus 60, the data bus 56 and certain processor state information. These detectors can be used to generate breakpoints and watch-points as part of the debug system. Breakpoints are events that cause the processor to stop executing instructions while watchpoints are events that are detected that only generate interrupts used by software based debuggers. When breakpoints are detected, the processor is halted if it is in the JTAG debug mode. In the present embodiment, the JTAG interface is the only interface capable of operating the processor using the hardware breakpoint system to halt the processor. The status, registers, coprocessors and memory can be examined or altered by the debug system while the processor is halted. Execution can resume by issuing a run command in the debug instruction register.

The event state detectors are designed to allow programming of trigger conditions that can make any or all of the bits in the address registers and the data registers as sensitive to the detection. The status bits may be used as qualifiers which define the trigger for the type of operation that corresponds to the address and data comparisons.

FIG. 5 is a block diagram schematic of a breakpoint/watchpoint detector suitable for use in the debug system of FIG. 1. Referring to FIG. 5, each detector is capable of monitoring the data bus 56, address bus 60, processor modes, processor transfer types and directions. The exemplary detector shown in FIG. 5 monitors the address bus 60 utilizing a virtual address register 90 and bit compares that address in a set of exclusive OR gates 92 with a breakpoint/watchpoint CORE address stored in another register 94 of the grouping of the detector. Each bit comparison is further qualified in a set of NAND gates 96 by the contents of an address mask register 98 that designates which bits should be used in the address bit comparison. An AND gate 100 monitors the outputs of the set of NAND gates to establish a match in the designated bits of the monitored address. If the processor has qualified that the address bits are valid, then a match condition is stored in a detector valid storage element which for the present embodiment is a D-type flip flop 102. The output of the storage element signals over line 104 an address match to a final comparison circuit.

Still referring to FIG. 5, a similar circuit arrangement is configured for the monitoring the data bus 56. For data events, a data register 106 is utilized to monitor the data bus 56 and that data is bit compared in a set of exclusive OR gates 108 with a breakpoint/watchpoint CORE data stored in another register 110 of the grouping of the detector. Each bit comparison is further qualified in a set of NAND gates 112 by the contents of a data mask register 114 that designates which bits should be used in the data bit comparison. An AND gate 116 monitors the outputs of the set of NAND gates 112 to establish a match in the designated bits of the monitored data. If the processor has qualified that the data bits are valid, then a match condition is stored in a detector valid storage element which for the present embodiment is a D-type flip flop 118. The output of the storage element signals over line 120 a data match to the final comparison circuit.

Further, in the embodiment of FIG. 5, the contents of the debug address and the address mask registers define the conditions that are used to detect a matching address condition. The mask register indicates which bits are to be considered valid in the address register. A “1” in the mask register indicates that the corresponding bit in the address register shall be compared with the address being scanned by the system while a “0” in the mask register indicates that the bit is a don't care and can be any state for that bit. In this embodiment, the address, address mask, data, & data mask registers R2, R3, R4 & R5, respectively, correspond to the breakpoint-watchpoint detector 0 while the address, address mask, data, & data mask registers R6, R7, R8 & R9, respectively, correspond to the breakpoint-watchpoint detector 1.

The processor operates in several different modes that allow further discrimination of the operations being performed in the processor. The address and data match signals can be used to allow the detector to screen out unwanted detections performed in modes and operations that do not pertain to the debugging being performed. Additionally, actions can be further specified for each breakpoint/watchpoint detector that may allow it to further refine detection only to read and write operations. When the detection is correct for a proper qualifier mask and action mask as shown in FIG. 5, the result is then combined in an AND gate 122, for example, to generate an output detection signal “Found” that may be passed on to the debug control system. At the end of each processor cycle period, the address and data storage registers are cleared to allow resynchronization of each event detector with the next processor cycle.

More specifically, a debug mask section 123 of the embodiment of FIG. 5 is divided into two basic sections that correspond to the qualifier mask and action mask detection of each event detector 0 and 1. Each section monitors special trigger bits of the processor and identifies qualifier mask bits utilizing a set of registers 124 and 126 and action mask bits utilizing a set of registers 128 and 130, for example. In the present embodiment, these mask and action bits define the state of the processor system being monitored. If a system qualifier bit is determined to be a logical “1”, then debug detector hardware utilizing a set of AND gates 130, a corresponding set of D-type flip flops 132, and an OR gate 134, for example, will go true. If the proper action bit is also determined to be a logical “1”, then similar debug detector hardware utilizing a set of AND gates 136, a corresponding set of D-type flip flops 138, and an OR gate 140, for example, will go true. If both qualifier and action states are proper or true as determined by an AND gate 142, for example, and the event detector gets a qualified condition on both the data and the address compare circuits 118 and 104, respectively, then the “Found” signal will be generated via the AND gate 122.

The qualifier bits of the mask registers 124 and 126 are used to identify the mode that the processor is in during an operation. The processor system allows the software to switch between various modes of operation depending on the state of the system. These modes depend on the state of the processor and activities and software being executed. The event detectors may be set to trigger only if they are in a particular mode. Any or all modes can be set for detection allowing the debug system to refine a trace condition to a particular system or code segment. This further allows the debug system to perform track mode switching without address or data values. A “0” in a system mode qualifier bit prevents the event detectors from triggering via AND gate 122, for example, on activities which are generated in that mode. The following modes can be traced using the debug system: Detect on System Mode, Detect on Undefined Mode, Detect on Abort Mode, Detect on SVC Mode, Detect on IRQ Mode, Detect on FIQ Mode, and Detect on User Mode, for example. In addition, the transfer type qualifier bits of the register 124 allow the debug system to uniquely identify a data transfer type that may occur in any of the above modes. The transfer type bits identify what processor sub-system is performing the operation. The user can qualify on any or all of the following transfer types and may indicate at least one condition for a trigger to occur: Break on Instruction Fetch, Break on Data CPU Access, Detect on MMU table read, Detect on DMA 0, Detect on DMA 1, Detect on DMA 2, and Detect on DMA 3. Moreover, A trigger may be also qualified on the direction of the individual data direction of transfer related to the processor. In addition, one or both of the following action bits: Break on Read and Break on Write, for example, may be determined utilizing the registers 126 and 128 and associated debug detector circuits to get a trigger condition.

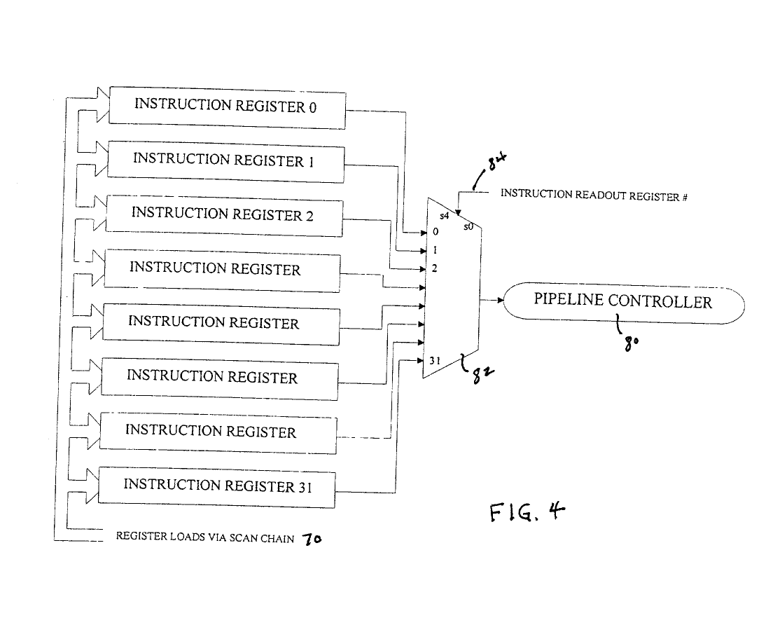

The debug control register R0 of the embodiment of FIG. 2 is used to govern the operations of the debug system in four basic mode configurations: (1) Complete debug operation by use of the JTAG interface and an external debug monitor that performs debugging of the target processor system using the debug port; (2) A local processor resident debug monitor that communicates to the debug host using the JTAG interface; (3) A local processor resident debug monitor without the JTAG interface. (In this mode the host could communicate with the target system using another interface, such as an on-chip UART or ethernet interface, for example); and (4) No debug operation functionality, but the embedded debug system components may be utilized to perform non-debug operational functionality such as memory protection and software repair functions, for example. The table depicted in FIG. 6 exemplifies the states of the debug control register R0 through the aforementioned modes.

More specifically, referring to FIG. 6, the Enable debug control bit (bit 0) turns on the Debug circuits. When enabled, the hardware allows debug system functions to be switched on and off depending on the state of the function bits 19 through 22 of the debug control register R0. The enable debug ROM mode bit (bit 1) indicates that the debug system is to utilize resident debug software to execute a debug monitor program. This bit when set prevents the debug event detectors from halting the processor, and when cleared (running in JTAG debug mode) enables the event detectors so that when a qualified event is detected, the processor will be halted to allow the external JTAG debug system to perform debug operations. The JTAG Installed bit (bit 2) is a status bit that indicates that the JTAG interface is installed. The bit may be used by the ROM-based debug monitor to indicate that communications therewith can be established via the four general purpose registers R11 through R14. This bit is also used to indicate to the software the configuration of the debug registers. This bit generally reflects the state of the JTAG Installed bit, bit 6, in the Debug Instruction Register 72. The event detector 0 Enable bit (bit 3) enables event detector 0 to generate an output based on the address, data and qualifier bits. A “0” in this bit position disables the detector circuitry and prohibits the generation of interrupts or trigger signal outputs. If the detector is disabled, registers R2 through R5 can be used as read-write registers for communication between the JTAG interface and processor software. The Enable Detector 0 Breakpoint bit (bit 4) is set to a logic “1” to enable the breakpoint capability of detector 0 and to halt the processor when running in JTAG debug mode. When running in software debug mode from an on-board debug monitor, a high level on this bit enables an interrupt generated by detector 0 to be passed to the interrupt controller. If this bit is programmed as a logic “0”, detector 0 is disabled from generating an interrupt or a halt condition when the event is detected, but is permitted to generate an output signal indicating that a breakpoint/watchpoint detection occurred using the output trigger 0 pin if enabled. The detector 0 Trigger Output Enable bit (bit 5) when set enables the trigger output of detector 0 to be driven by the debug detection circuits, and when cleared the trigger output is driven by a Manual trigger bit (bit 6) of the control register. The trigger output may be selected to output high when the event of event detector 0 is valid or when the completion of both event detectors 0 & 1 are valid. The selection is programmed with bit 11 (Sequence enable mode) of the debug control register.

Moreover, the Detector 1 Enable bit (bit 7), Enable Detector 1 Breakpoint bit (bit 8), Detector 1 Trigger Output Enable bit (bit 9) and Manual Trig 1 Output State bit (bit 10) perform the same or similar functions as bits 3-6 except for the detector 1 group of registers R1, R6-R9. The Sequence Detect Mode bit (bit 11) configures the hardware to require detector #0 to detect an event followed by a detection of an event on detector #1 before output trigger 1 fires. Once the two sequential events have been detected, the appropriate event detector will signal a hit success (refer to FIG. 2A). The Sequence Interrupt Enable bit (bit 12) allows interrupts to be generated by the debug hardware from the sequential event detector. This mode is used to perform local debug monitor functions and is not used when performing JTAG debug control. The Debug Halt DMA bit (bit 13) when set causes the DMA system to stop operation whenever the system enters Debug mode and when using JTAG as the debug system. The DMA processor systems will halt when the processor halts and wait on service or commands from the JTAG interface. When the system is operated using a local debug monitor the operation of the DMA system is not affected. When this bit is cleared to logic “0”, the DMA operations are not halted regardless of the state of the debug system. If debugging is not enabled (i.e. Bit 0=“0”) then this bit has no affect.

Still further, The Debug Halt Timers bit (bit 14) when set causes the four counter/timers to stop operation whenever the system enters Debug mode. The counter/timers will halt when the processor halts and wait on service or commands from the JTAG interface. When the system is operated using a processor resident debug monitor, the operation of the counter/timers is not affected. If this bit is cleared to logic “0”, the counter/timers are not halted regardless of the state of the debug system. If debugging is not enabled (i.e. Bit 0=“0”) then this bit has no affect. The Debug Halt Scrubber bit (bit 15) when set causes the memory scrub system to halt whenever the system enters Debug mode and when using JTAG as the debug system. The scrubber will halt when the processor halts and wait on service or commands from the JTAG interface. When the system is operated using a procesor resident debug monitor the operation of the memory scrub is not affected. If this bit is cleared to logic “0”, the scrub operations are not halted regardless of the state of the debug system. If debugging is not enabled (i.e. Bit 0=“0”) then this bit has no affect. The Debug EDAC disable bit (bit 16) when set disables the EDAC checking system while the system is in Debug mode. When debug is being performed using JTAG, the JTAG system is responsible for setting the condition of this bit. When the processor is operating using a processor resident debug monitor, the bit can be altered using software. This bit, if set, disables the checking of EDAC during debug mode, but does not prevent the system from writing EDAC codes during debug mode. This bit does not affect the normal processor operation with respect to EDAC facilities control.

Further yet, The Detector 0 Found bit (bit 17) is set to indicate that a match was found by breakpoint/watchpoint detector 0. Both the JTAG and software debug monitors can read this bit to identify a detector 0 breakpoint or watchpoint hit. Likewise, Detector 1 Found bit (bit 18) is similarly set to indicate that a match was found by breakpoint/watchpoint detector 1. Both the JTAG and software debug monitors can read this bit to identify a detector 1 breakpoint or watchpoint hit. Neither of the bits 17 or 18 may be set by processor software. The Sequence Found bit (bit 19) is set to indicate the event detection of a qualified Sequential operation caused by detector #0 qualifying first followed by detector #1. The Debug Entry Reason bits (bits 21,20) indicate the reason that debug mode was entered. When in JTAG mode these bits are set to the following values: 01—Stop command issued (JTAG IR Run Bit set to 0), and 10—Breakpoint detected. The Instruction execute on breakpoint bit (bit 22) when set causes the instructions programmed into the IQ 38 to be executed when the next breakpoint is detected. The Delay N triggers to break bit (bit 23) defines the use of the counter setting (bits 25 to 31). When this bit is set, the debug system executes N qualified event detections before a trigger output is generated. When this bit is cleared, N defines the number of times that the instruction buffer is to be executed in debug mode. The Execute Debug Instruction Queue bit (bit 24) when set causes the instructions of IQ 38 to be executed by processor software. This bit may be set by software when the processor is not in the JTAG debug mode. When the processor is in the ROM debug mode, the debug system will allow the resident ROM debug monitor to execute the IQ. The contents of the last register IR31 in the IQ 38 indicates in which register of the IQ the last valid programmed instruction is located. The Count value register (bits 25 to 31) holds the count value that is used for repeat counts. The number programmed into the bits 25-31 is equal to the number of events/delays which the system is to perform −1. [N=(events−1) or N=(delays−1)].

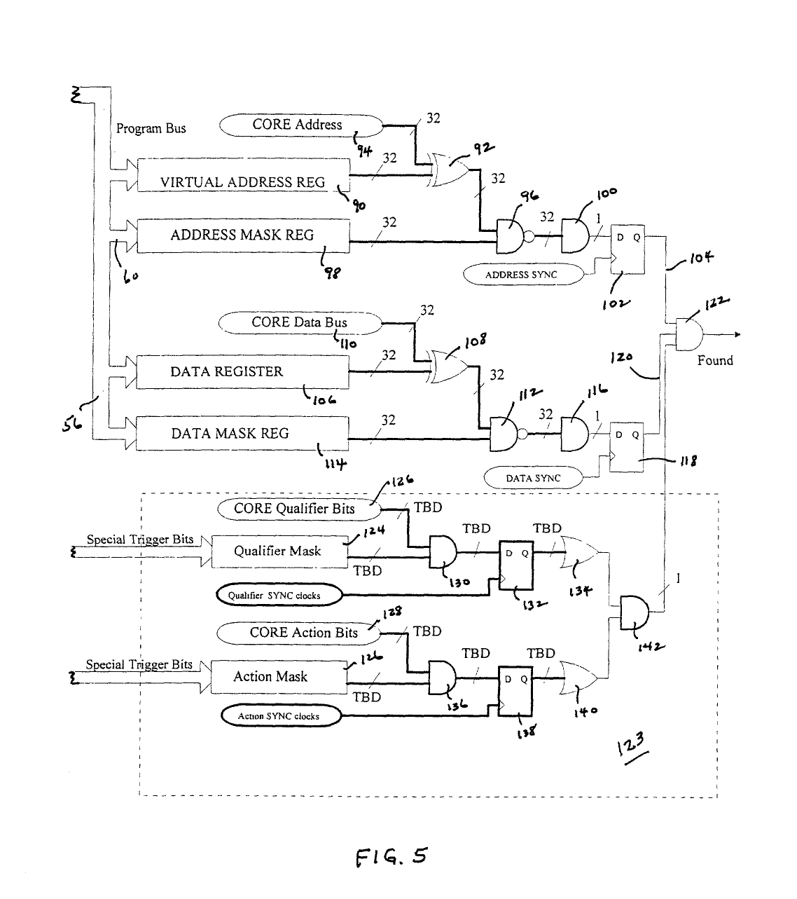

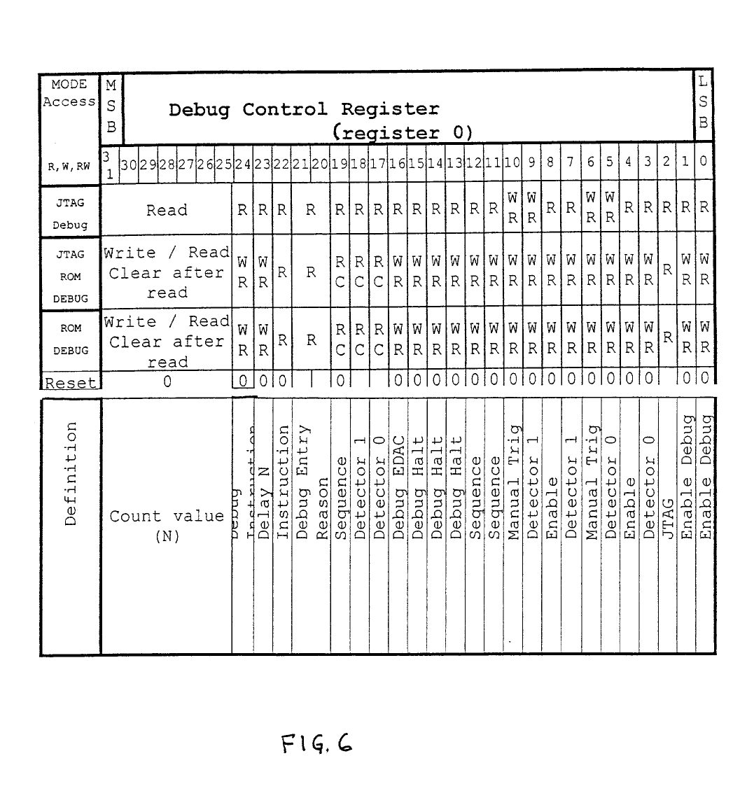

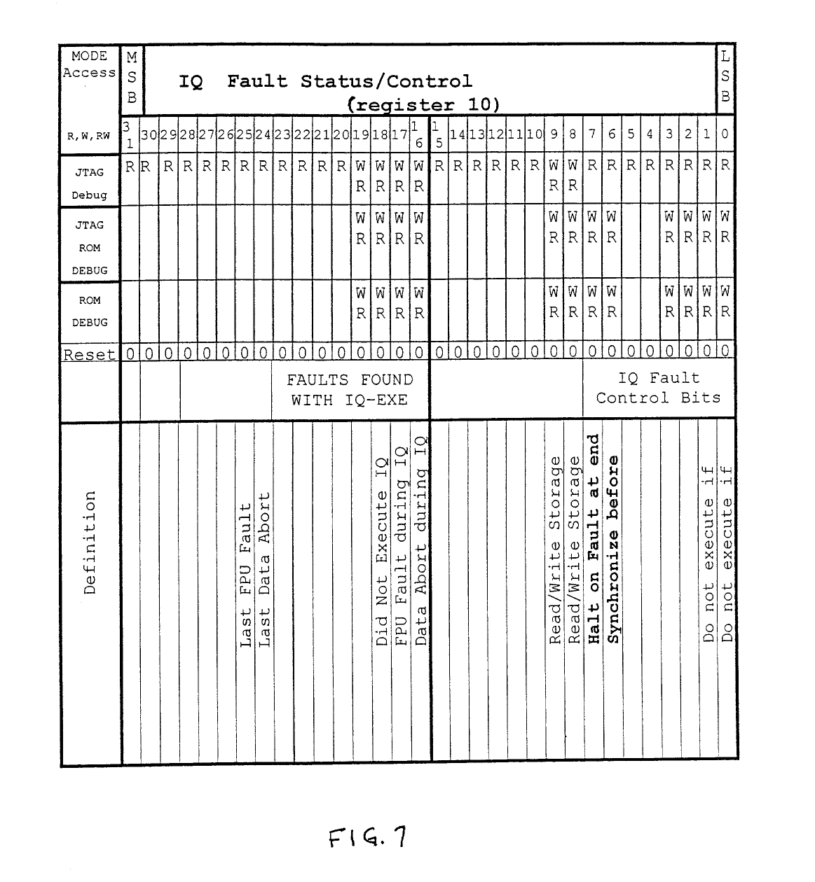

An IQ Fault Status/Control register offers a method of blocking execution of the instructions of the IQ 38 when there are existing or pending faults within the processor system prior to such execution. It also allows viewing what errors occur during the execution of the IQ and a method of handling those errors. The contents of this control resister may reside in register R10 and can be read from and written to by the JTAG system or processor system software. The table of FIG. 7 exemplifies the status of the bits of the register through the various modes and conditions.

Accesses made to the Debug system registers are allowed for supervisor mode. Accesses made while in user mode for the most part are not allowed. The table shown in FIG. 8 exemplifies the user mode accesses that are allowed and the faults generated for the user mode accesses that are not allowed.

The JTAG interface may be installed to allow for foundry testing, software development & manufacturing testing. Foundry testing is comprised of all testing to verify scanning for all low level flip flops and logic and to verify that the scanned target processor system is not at a stuck condition. The foundry testing utilizes the standard boundary scan capability with necessary changes inserted to allow for operational development requirements listed below.

Operational development specifications are based on the scan chains being organized around a structure that will allow the JTAG system to examine and control the status registers in the debug system, while the target processor system is running at full speed. Accordingly, the JTAG IR 24 contains the appropriate signal bits to cause the processor system to read and write data from and to the debug system asynchronously to the processor clock.

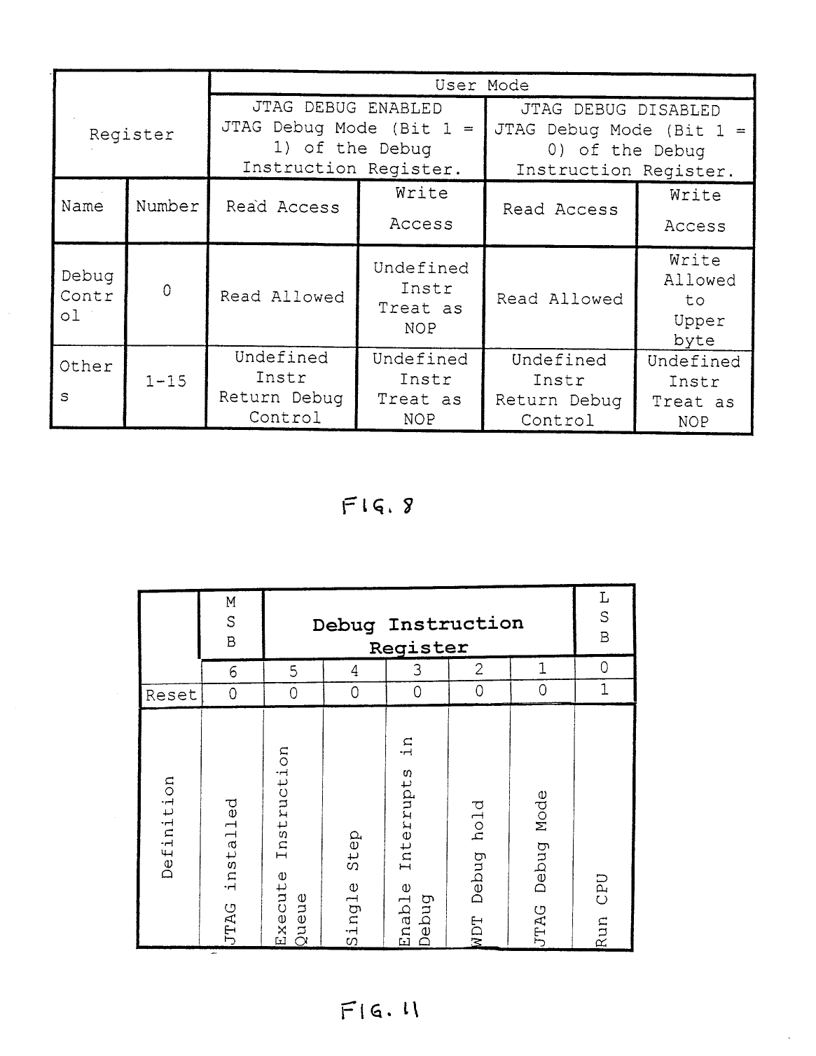

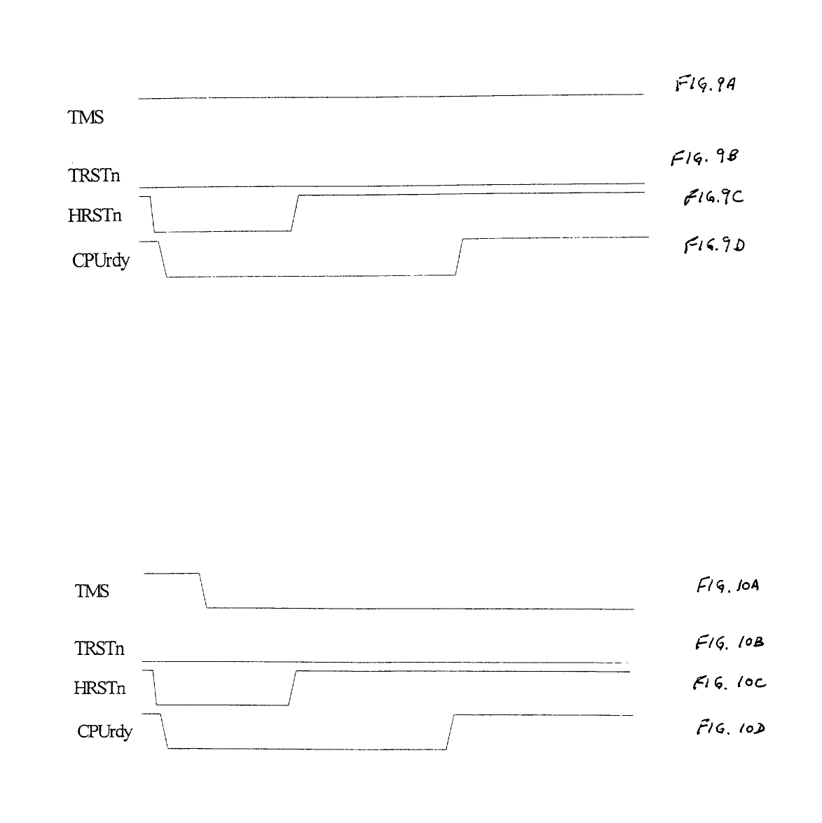

The JTAG TMS and TRSTn input signals of the present embodiment allow the processor system to power up in one of a plurality of basic configurations such as Normal Boot (Start execution at address 0 and run), and Serial Boot (Use serial boot loader to load internal memory), for example. These signals define the start of execution location in memory and controllability of the system after a hardware reset is de-asserted. For the most part, the JTAG interface is supplied with the hardware reset to allow the signaling to be accomplished via software control. For a normal boot mode, the relationship between the TMS, TRSTn JTAG control lines and the hardware reset input HRSTn is given in FIGS. 9A-9D. Referring to FIGS. 9A-9D, to start in the normal boot configuration, the TRSTn line shall be held low in the reset state to keep the JTAG controller from operating. This JTAG TAP reset control is asynchronous and will be tied to ground for non-JTAG operation. FIGS. 10A-10D exemplify the signaling to be accomplished to cause the processor to execute the serial boot loader which may be located in the instruction queue 38, for example. Referring to FIGS. 10A-10D, the TMS line should be low when the CPUrdy line goes active. Whenever this condition exists after hardware reset, the processor will jump to the memory mapped register of the instruction queue 38 and begin executing it. If this mode is entered, the JTAG system should not use the instruction queue 38 until the boot program has been loaded and is executing in internal memory.

For debug operation, the JTAG scan chains 70 may be organized so the processor system can have a debug system that will allow uninterrupted processor operation in the foreground while the JTAG scan chain 70 is controlled to scan into and out of the debug system data, instructions and status and control information in the background. JTAG and debug instruction registers may allow the processor to be halted or run using the JTAG instruction register bits, for example. When in the halted debug mode, the external interfaces shall operate normally to allow for external clocking operations and access during debug operations. The scan chain 70 may also allow full JTAG compliance for boundary scan operations.

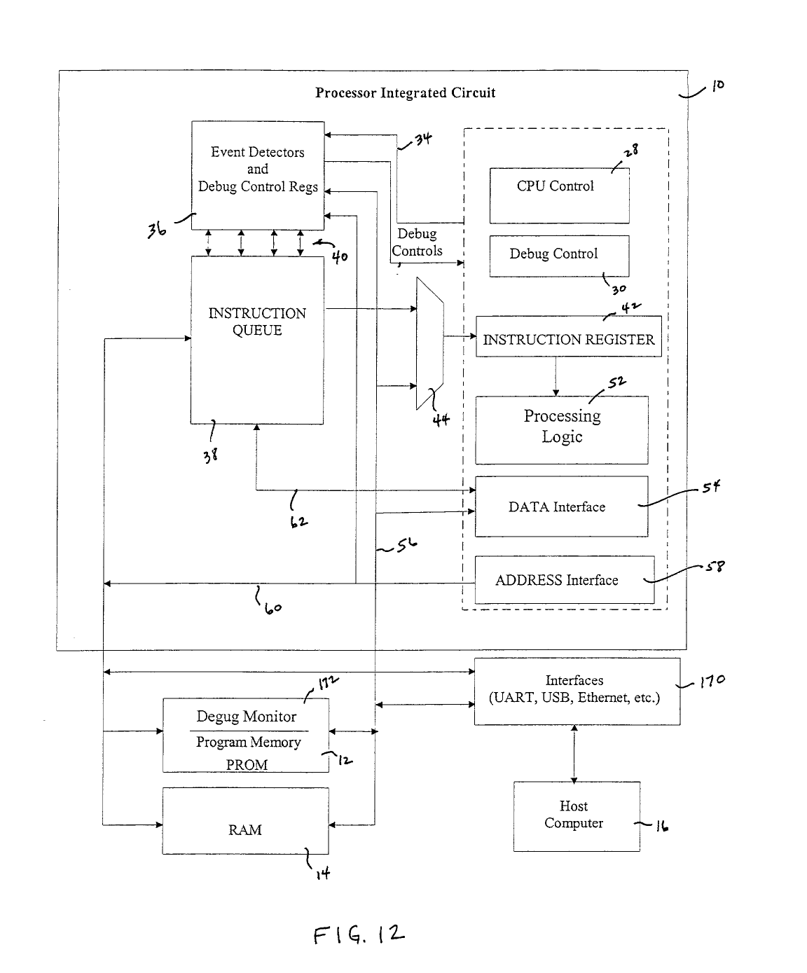

The examination/alteration of basic processor systems such as the registers of the core, coprocessors (other than the debug system) and memory may be done by placing special code into the instruction queue 38 followed by a command in the bits of the debug instruction register 72, for example, to execute the special code. The table of FIG. 11 exemplifies a definition of the control bits of the debug instruction register 72 suitable for use in the embodiment of FIG. 2.

Referring to FIG. 11, when Bit 1 is set, the JTAG interface is controlled to operate in Debug Mode. Also, if Bit 0 is cleared to “0”, the processor is controlled to halt execution at the next available instruction break. Bit 0 may be set to “0” by the JTAG scan chain 70 or by the event detector systems 36 in the debug system which command a processor halt if the processor is in JTAG Debug mode. Bit 0 may also be cleared by the operation of a single step operation or instruction queue operation completion. In addition, when Bit 0 is set, the four memory mapped locations at offset 0×7400 function as a stack for branch instructions where the branch was taken, and when this bit is cleared to “0”, these four locations act as independent memory locations. The contents of the four registers are reset to “0” when the “Run CPU” bit (Bit 0) transitions from a logic “0” to a logic “1”.

There are two modes of operation in which the debug system operates. The first mode (JTAG Debug Mode, Bit 1=1) allows a host debug monitor to use the JTAG interface to control operations of the debug system. The second mode (Bit 1=0) of debug operation controls the processor system to run a resident debug monitor. Accordingly, Bit 1 functions to control whether or not the processor may be halted. If Bit 1 is not set, the processor may not be halted. The two modes differ by their use of the embedded circuitry to control the debug system. In the first mode, the debug system does not use a resident debug monitor but performs actions on the processor using hardware to read/modify systems. In this mode, the processor may be halted by the hardware and the external host debug system controls the debug process and transfers. In modes that use a resident debug monitor, the processor may signal events to the resident debug monitor by issuing an interrupt rather than halting the processor. Conditions that will allow Bit 2 to halt the processor are those which are issued by the JTAG interface when the TRST* signal is not active. Bit 2 may be qualified by the TRST* signal to verify that the watch dog timer of the processor system is never deactivated when the system is not in JTAG debug mode. The host system may set this bit to cause the watch dog timer to freeze whenever the processor is halted due to a debug operation. The reset default for Bit 2 is to hold the watch dog timer when in debug mode. The watch dog timer may not be on hold when a debug operation is being performed using a resident debug monitor. Whenever resident software based debug monitor is used, the monitor is responsible for signaling the watch dog timer system to prevent watch dog time-outs.

When operating in debug mode (i.e. the processor may be halted), Bit 3 when cleared to “0” masks interrupts to the processor, which is the state of Bit 3 for the power on default. This bit can be set via the JTAG debug function to allow interrupts to be received by the processor while in debug mode. Also, when the processor is halted in debug mode, the host debug software may execute a single instruction operation by setting Bit 4 to “1” along with the Run CPU bit. The Run CPU bit may automatically clear itself after each single step has started. The processor shall execute one instruction each time this bit sequence is set. Further, Bit 5 when set along with the Run CPU bit 0 set to 1 by the JTAG interface causes the instructions in the instruction queue 38 to be inserted into the processor core instruction pipeline and executed by the processor substantially without interruption of the instruction execution stream thereof. The number of instructions executed depends on the instruction characterization identified in the designated register of the instruction queue 38. In addition, the instructions of the instruction queue 38 may be accessed and executed repetitiously the number of times identified in the count bits (25 to 31 in the Debug Control Register) plus 1. This operation of the IQ 38 provides for a very fast “memory fill” capability, for example. On completion of execution of the sequence of instructions of the instruction queue 38, the Run CPU bit may be cleared if the sequence was entered from the halt mode. This Bit 0 may automatically clear to “0” when the execution of IQ instructions has completed.

The JTAG instruction register 72 may have two private instructions to allow the JTAG interface to configure its TAP controller to communicate to the scan chains 70 tied to the embedded debug system. The JTAG scan chain 70 may execute the normal public instructions, (BYPASS, SAMPLE/PRELOAD AND EXTEST) for operation with other JTAG devices. In addition, the scan chain 70 may support the IDCODE instruction indicating a manufacturer identification code which may translate to a JTAG identify code JTAG manufacturer identification code. Debug read and write instructions may be included that configure the JTAG system to read or write debug and instruction queue registers. The JTAG instruction may identify the register thereof to be read or written. Once the JTAG instruction register 72 is configured, the debug system allows communication to the programmed register and the Debug instruction register via a forty-bit scan chain, for example. The operation of the scan chain 70 when communicating to the selected registers in the debug system may be configured to allow maximum data transfer rates to and from the host system 16 running the JTAG interface 22.

In view of the foregoing description, the debug system of the present embodiment contains functionality similar to a logic analyzer, for example. Registers in the debug system may be programmed to compare various processor information in real time and generate a trigger signal when an event match, such as a breakpoint or watchpoint, for example, is determined between the processor state and the programmed event register contents. Typically, to set an event point, like a breakpoint, for example, in present types of systems, the host computer would replace the breakpoint address with a software interrupt instruction vectored to the resident debug monitor program. When the address is executed the code would save the current instruction and then branch to the resident debug monitor that reports to the host computer indicating a breakpoint occurred.

In contrast, the debug system of the present embodiment is programmed with the address of the breakpoint. The debug system then compares the address internally and generates a trigger when an address match occurs. The external memory image does not have to be modified. Also, the debug system of the present embodiment has the capability of monitoring address, data, control signals and processor mode events. Because of this approach, very specific watchpoints and breakpoints as well as other events may be set. Also, a counter in the debug system may permit an event trigger to be generated after a certain number of event matches occur. When an event trigger is generated, the state of the processor system may be inspected and/or modified (using IQ instruction sequences) as necessary to suit the software developer. As an example, a breakpoint may be set on the 100^{th} occurrence of data value ABC being written to address XYZ only when the processor is in supervisor mode. In addition, the event detection system of the present embodiment cooperates with the auxiliary IQ which may be configured to execute when an event, like a breakpoint or watchpoint is detected. In cases where it is necessary to capture information in the processor with minimal impact on the running code, the IQ can be programmed with a sequence of instructions to examine the CPU register, coprocessor register or memory location. When the event is reached, the instructions of the IQ may be promptly and automatically accessed and inserted into the instruction pipeline to be executed, thus allowing the instruction sequence to run and capture the designated data in sufficient time. The impact on the executing program would be minimal (usually less than 32 processor clocks). The host may then examine the results in the debug system storage registers in the background via the communication interface and scan chain.

In addition, the two event detectors 0 and 1 of the debug system embodiment of FIG. 2 may operate independently or in sequence. The circuit schematic of FIG. 2A exemplifies an embodiment for operating the two event detectors 0 and 1 independently or in sequence. Referring to FIG. 2A, a trigger signal from event detector 0 is coupled to the input of a trigger flip flop 150 over line 152 and passed on to the debug control circuit over line 154 (Trigger 0). A trigger signal from event detector 1 is coupled to one input of an AND gate 156 and one input of a multiplexer circuit 158 over line 160. A Q output of the trigger flip flop 150 is coupled to another input of the AND gate 156 the output of which being coupled to another input of the multiplexer circuit 158. A select signal which may be generated over line 162 from the debug control circuit, for example, governs the multiplexer 158 to select between independent and sequential operation of the event detectors 0 and 1. When independent operation is selected, the trigger signal from event detector 1 is passed on to the debug control circuit via multiplexer 158 over line 164 (Trigger 1), for example. When sequential operation is selected, trigger signals from both of the event detectors 0 and 1 are detected by the AND gate 156 utilizing the flip flop 150 and a signal effected by AND gate 156 is passed on to the control circuit over line 164 via multiplexer 158, for example. In sequential operation, a breakpoint, for example, may be set when read of a data value 123 from address 456 in user mode occurs (signal 160) only after a first detection (signal 152) of the 100^{th} occurrence of data value ABC being written to address XYZ with the processor in supervisor mode. Furthermore, portions of the address, data, controls and mode fields can be programmed to be “don't cares”. The debug system could breakpoint on a read or write of a range of data values within a range of addresses. In other words, extremely complex event sequences may be configured in the debug system of the present embodiment.

The sequencing circuit embodiment of FIG. 2A allows the generation of trigger signals over lines 154 and 164 that may be connected to the debug control circuitry and/or to external pins of the IC processor 10, for example. These signals are designed to generate pulse information that may be used for both debug purposes performed internal to the IC processor and for measurements made externally using test equipment or for synchronization of multiple processor systems.

To give added value during operation, the debug system is configured to be also accessible by the operating software of the processor system. This extends the operational capabilities of the auxiliary IQ to the operating system. An example of the extended capabilities is the debug system's ability to detect when address ranges are accessed that are outside the bounds set up in the event detector circuitry. The intent would be to have the IQ execute its instructions when an address is accessed that is not in the normal range of execution. Another feature may be programming the IQ with a non-debug instruction sequence controlling it to perform an instruction sequence insertion without the overhead needed using call or interrupt handling. Since call and interrupt handling instructions need special considerations related to retaining the return address, much time is saved by utilizing the IQ to execute instruction sets since it is memory mapped and operates in a virtual address space.

Also, Since the processor system of the present embodiment is capable of performing debug operations without external software, it can be used to test and load the external systems. An example is manufacturing a single board computer with standard parts such as unprogrammed EEPROMs (Electrically Erasable Programmable Read Only Memory) and programming the board after manufacturing. This allows for testing the EEPROMS for errors by writing patterns to the devices after they are in circuit and then programming them with the final code. This also allows the checking of board memory after it is in it's final deliverable configuration.

In an alternate embodiment of the present invention, the debug system of the present invention may be used without a JTAG type communication interface. For example, in applications where software developers use other forms of host communication interfaces, like serial peripheral interfaces such as UARTs, USB or ethernet interfaces, for example, or parallel peripheral interfaces such as SCSI interfaces, for example, the debug system may operate with an embedded debug monitor. In this mode, the monitor program provides many of the debug functions. The powerful event detector system would still provide non-invasive functionality. Modifying the target processor system's monitor program can easily expand such a debug system embodiment. Actually, the “monitor” in this alternate embodiment could simply be a communication interface between the user or host interface and the embedded debug system. Since the processor software can write and initiate the IQ instruction sequences, the communication interface could simply parse a debug message, write an IQ instruction sequence to the IQ and command it to execute. When used in this way the resident monitor may be very much scaled down from a typical embedded monitor. This requires less memory to be allocated to the debug monitor allowing more to be used by user applications. Also, the event detection may be used unmodified for this type of system reducing the invasiveness of the debug system.

It should be pointed out that the auxilliary IQ 38 in the present embodiments may be programmed via the JTAG port and/or programmed by the processor writing data to the IQ. In the former case, a serial interface may be used to input the control and data to the IQ, but this data may be also input using a parallel port or other means such as special purpose JTAG interface boxes that interface to the host using serial or parallel ports. In the latter case, the data for programming the IQ arrives from the host device into the processor system by any means and the processor executes an embedded debug monitor that programs the instructions into the IQ. A suitable embodiment for this latter operation is depicted in the block diagram schematic of FIG. 12.

A block diagram schematic of an embedded debug system using an alternate communication interface is shown in FIG. 12. Referring to FIG. 12, reference numerals of elements of the processor and debug systems previously described will remain the same for this embodiment. In this alternate embodiment, the connection between the IC processor 10 and the host device 16 is performed by a peripheral interface 170 which may be coupled to the address bus 60 and data bus 56 of the processor. This interface may be a serial or parallel peripheral interface of any of the types previously described to permit communication between the host device 16 and a debug monitor 172 programmed in the program memory 12, for example, over the processor buses 56 and 60. In this embodiment, the debug monitor 172 may use the debug system to set breakpoints in the user software. When a match is detected by the user software, the processor system may utilize the IQ 38 as previously described or interrupt the processor causing it to branch to the debug monitor 172 wherein debug operations are performed under control of the host device 16 via communications over the peripheral interface 170. This mode of operation allows code to be debugged when located in a read-only-memory (ROM) of the processor system by the execution of the debug monitor program 172 each time an event programmed by the host device, for example, is detected. The debug monitor program 172 may perform single step operations by advancing the breakpoint address register and returning to the user code.

In yet another embodiment of the present invention, since the auxiliary IQ is memory mapped and exists in the memory space of the processor system, it may be accessed by the processor system, if needed. As such, the auxiliary IQ may be read and written either by the JTAG interface or the embedded application code of the processor system. Accordingly, when the auxiliary IQ is not being used as a queue, the registers of the IQ may be loaded with programs just as with any other location in a memory of the processor system. In this mode, the IQ need not be “initiated” by anything. The processor may simply branch into the mapped memory area of the IQ and continue executing. One potential application of this embodiment is that executing instructions from this memory would not cause an embedded cache to be operated. At the same time, external memory would be idle since the processor is executing from the embedded IQ memory. This application of the alternative embodiment will result in a lower power dissipation mode for the target processor system.

Another aspect of this alternate embodiment is that it may be utilized as a potential “safe mode” for the processor when it is subjected to high radiation type upset transients, like solar flares, for example. Since in this alternate embodiment, the processor and IQ registers are fabricated using special design and fabrication methods that allow these registers to survive through extreme environments, a program of the processor system may detect the inception of an event by monitoring certain sensors coupled to the processor system and trigger a process defined by a sequence of instructions that can run from the IQ which stores the state of the machine in the IQ, for example. The processor may continue to monitor the event by reading sensors to determine when the event has ended. Thereafter, the data stored in the IQ can be reloaded to its respective registers of the processor system, thus restoring the state of the processor system back to the operational state at inception of the event. This type of configuration would allow sensitive sections and parts of the processor system, such as EEPROMs, for example, to be powered down before upset transients from an event could impart damage to such parts and sections. This hibernation mode allows the processor state to be stored while other sections of the processor are in sleep or powered down mode.

The processor system of the present embodiment has several power-up modes of operation. The power-up configurations in one embodiment are controlled by the state of the JTAG signals TMS and TRSTn during a program reset process. One mode permits the processor to power up running from a reset vector which is normal execution for a processor (refer to FIGS. 9A-9D). Another mode permits the processor to power up in JTAG communication mode with the processor halted or with the processor running. This mode is typically used during software development. Yet another mode permits the processor to be powered up into what is known as serial boot mode (refer to FIGS. 10A-10D). A feature of present systems including a cache is that at power up, the cache memory system goes through a built-in self test (BIST). When BIST is complete, the cache is designed to initially act like an on-chip memory, and not a cache. To the processor the cache looks and acts just like memory and thus, may be enabled by software during the normal booting operation.

In yet another alternate embodiment of the debug system, the IQ includes storage elements (i.e. flip/flops) and the state of each storage element may be configured, i.e. set or reset, upon a system reset. Accordingly, the registers of the IQ may be hardware configured to contain the program code of a small boot loader which configuration may be effected by a power up in serial boot mode condition. Thus, when the processor system is powered up in serial boot mode, it may be caused to jump to an IQ memory location, instead of the program reset vector, and begin executing the boot loader program of the IQ which may be of the type that looks for data from an on-chip UART communication interface, for example. This serial boot loader configured into the IQ may have the ability to load 1024 bytes of data plus a one CRC (cyclic redundancy code) byte and load each into the cache memory area, for example. In this example, when the load is complete and the loaded instructions pass a CRC check, the execution of the processor system software jumps to the beginning of the cache memory and begins executing the loaded program. The 1024 byte program that is loaded into cache could simply be a bigger loader or it could be an entire small application. The processor system may continue to execute code from the on-chip cache memory until the software decides otherwise.

The advantages of this embodiment and mode of operation thereof are numerous. From a testing standpoint the on-chip memory could be loaded with a program designed to automatically test the computer system (the processor, external memory chips, external interfaces) without knowing whether the external memory system is good. Without this feature, in order to have a computer perform its own self test the external memory system and associated control logic (FPGAs, etc) all must work properly to perform the test. Debugging the hardware at this point is difficult.

The processor system could also be used in a very minimal system configuration that does not include external memory components. The processor would have to be loaded at power up with its operating software and would then simply execute from its own internal memory. This has advantages in that high-speed processors could be distributed in many locations on a vehicle to provide data processing local to data collection, a payload for example, and simplify vehicle harnessing, saving weight and integration complexity. The processed data could then be sent over the other integrated UART to a central processing element. Depending on the performance required this system could be operated at a slower speed providing a low power solution to the data processing application.

While the present invention has been described herein above through use of a number of embodiments, it is understood that this was done solely by way of example, and that the present invention should in no way be limited to any such embodiment. Rather, the present invention and all aspects thereof should be construed in broad scope and breadth in accordance with the claims appended hereto.

We claim:

1. Apparatus embedded in a processor system comprising:
an auxiliary instruction queue (IQ) including a plurality of storage registers programmable with a set of instructions; and
control means for governing the programming of said auxiliary IQ with said set of instructions and for controlling insertion of said programmed instructions of said auxiliary IQ into an instruction execution stream of said processor system substantially without interrupting processing operations thereof.

2. The apparatus of claim 1 wherein the auxiliary IQ includes means responsive to an execution signal for accessing programmed instructions from the auxiliary IQ in a predetermined order for insertion into the instruction execution stream of the processor system.

3. The apparatus of claim 2 wherein the accessing means accesses the instructions from the auxiliary IQ in an addressable sequential order.

4. The apparatus of claim 2 wherein the accessing means accesses the instructions from the auxiliary IQ automatically in response to the execution signal.

5. The apparatus of claim 2 wherein the accessing means accesses the instructions from the auxiliary IQ at a rate commensurate with a processor system clock.

6. The apparatus of claim 2 wherein the control means includes means for gating the instructions accessed from the auxiliary IQ into an instruction pipeline of the processor system for execution by the processor system.

7. The apparatus of claim 2 wherein the auxiliary IQ includes a designated register programmable to characterize the set of instructions programmed therein; and wherein the accessing means is governed by the characterization of said designated register.

8. The apparatus of claim 1 wherein the control means includes means for controlling the operation of a program counter of the processor system during the insertion of the programmed instructions of the auxiliary IQ into the instruction execution stream of the processor system.

9. The apparatus of claim 1 including a host interface means; and wherein the auxiliary IQ includes means for receiving instructions to be programmed therein from an external host device through said host interface means.

10. The apparatus of claim 9 wherein the instructions are received from the host device through the host interface means and programmed into the auxiliary IQ without interrupting the processing operations of the processor system.

11. The apparatus of claim 9 wherein the host interface means comprises a JTAG interface including serial scan chains coupled to the instruction queue.

12. The apparatus of claim 9 wherein the host interface means comprises a host peripheral interface.

13. The apparatus of claim 12 wherein the host peripheral interface is selected from the group comprising a serial peripheral interface and a parallel peripheral interface.

14. The apparatus of claim 9 wherein the instructions received from the host device comprise debug instructions.

15. The apparatus of claim 14 wherein the control means includes storage registers for temporarily storing data for and resulting from the execution of the debug instructions; and wherein the control means includes means for controlling the transfer of data between said storage registers and the host device through the host interface means without interrupting the processing operations of the processor system.

16. The apparatus of claim 9 wherein the instructions received from the host device comprise instructions for transferring data between the host device and the processor system.

17. The apparatus of claim 16 wherein the control means includes storage registers for temporarily storing data for and resulting from the execution of the data transfer instructions; and wherein the control means includes means for controlling the transfer of data between said storage registers and the host device through the host interface means without interrupting the processing operations of the processor system.

18. The apparatus of claim 1 wherein the auxiliary IQ is memory mapped as part of a memory space of the processor system; and wherein the auxiliary IQ is coupled to a bus of the processor system for being programmed with instructions from the processor system.

19. The apparatus of claim 18 wherein the instructions received from the processor system comprise debug instructions.

20. The apparatus of claim 18 wherein the instructions received from the processor system comprise a serial boot loader.

21. The apparatus of claim 1 wherein the auxiliary IQ is memory mapped as part of a memory space of the processor system; and wherein the auxiliary IQ is coupled to a bus of the processor system for being programmed with data from the processor system.

22. The apparatus of claim 1 wherein the control means includes means for configuring said apparatus into a plurality of operational modes.

23. The apparatus of claim 1 wherein the control means includes at least one event state detector for triggering the insertion of the programmed instructions of said auxiliary IQ into the instruction execution stream of the processor system.

24. The apparatus of claim 23 wherein the control means is coupled to a bus of the processor system; and wherein the at least one event state detector comprises a breakpoint detector.

25. The apparatus of claim 23 wherein the control means is coupled to a bus of the processor system; and wherein the at least one event state detector comprises a watchpoint detector.

26. Debug apparatus embedded in a processor system that has a debug monitor program stored in a program memory thereof, said apparatus comprising:
an auxiliary instruction queue (IQ) including a plurality of storage registers programmable with a set of debug instructions, said auxiliary IQ being coupled to a bus of the processor system, said storage registers being memory mapped to render the auxiliary IQ part of the memory space of the processor system; and
control means for governing the programming of said auxiliary IQ with said set of debug instructions accessed from the debug monitor program over said bus and for controlling insertion of said programmed debug instructions of said auxiliary IQ into an instruction execution stream of said processor system substantially without interrupting processing operations thereof.

27. The debug apparatus of claim 26 including a communication interface for coupling the control means with a host system external the processor system for directing the operations of the control means through commands from the host system.

28. The debug apparatus of claim 27 wherein the control means includes storage registers for temporarily storing data for and resulting from the execution of the debug instructions; and wherein the control means includes means for controlling the transfer of data between said storage registers and the host system through the communication interface without interrupting the processing operations of the processor system.

29. The debug apparatus of claim 26 wherein the control means includes at least one event state detector for triggering the insertion of the programmed debug instructions of said auxiliary IQ into the instruction execution stream of the processor system.

30. The debug apparatus of claim 26 wherein the control means includes storage registers for temporarily storing data for and resulting from the execution of the debug instructions.

31. Protection apparatus embedded in an integrated circuit (IC) processor system comprising:
an auxiliary data queue (DQ) including a plurality of storage registers for temporary storage of data, each said storage register being fabricated in the IC to survive an upset transient, said auxiliary DQ being coupled to a bus of the processor system, said storage registers being memory mapped to render the auxiliary DQ part of the memory space of the processor system; and
monitor means for detecting an onset of the upset transient; and
control means governed by said monitor means for transferring data of selected registers of the processor system into registers of said auxiliary DQ for storage during said upset transient.

32. The protection apparatus of claim 31 wherein the data comprises instructions of at least one program.

33. The protection apparatus of claim 32 wherein control means is governed by said monitor means for program operation during said upset transient.

34. The protection apparatus of claim 31 wherein the upset transient comprises a high radiation upset transient.

35. The protection apparatus of claim 31 wherein the auxiliary DQ comprises majority voted registers; and including means for powering down systems external to the IC processor during the upset transient.

36. The protection system of claim 35 wherein the monitor means includes means for detecting an end of the upset transient; wherein the powering means includes means for restoring power to the external systems when said end is detected; and wherein the control means includes means for transferring data stored in the registers of the auxiliary DQ during the upset transient back to their corresponding processor system registers upon restoration of power.

37. The protection system of claim 31 wherein the monitor means includes means for detecting an end of the upset transient; and wherein the control means includes means for transferring data stored in the registers of the auxiliary DQ during the upset transient back to their corresponding processor system registers upon detection of said end.

38. The protection apparatus of claim 31 wherein the data of the selected registers of the processor system represent a state thereof at the onset of the upset transient.

39. The protection apparatus of claim 31 wherein the auxiliary DQ is programmable with instruction sequences and operable to insert said programmed instruction sequences into an instruction execution stream of the processor system.

40. Method of protecting an integrated circuit (IC) processor system against an upset transient comprising the steps of:
detecting an onset of the upset transient;
transferring data of selected registers of the processor system into upset transient survivable registers of an auxiliary data queue (DQ) upon said detected onset; and
storing said data in said registers of the auxiliary DQ during the upset transient.

41. The method of claim 40 wherein the upset transient comprises a high radiation upset transient.

42. The method of claim 40 wherein the data of the selected registers is transferred to majority voted registers of the auxiliary DQ; and including the step of powering down systems to the IC processor during the upset transient.

43. The method of claim 42 including the steps of detecting an end of the upset transient; restoring power to the processor when said end is detected; and transferring data stored in the registers of the auxiliary DQ during the upset transient back to their corresponding processor system registers upon restoration of power.

44. The method of claim 40 including the steps of detecting an end of the upset transient; and transferring data stored in the registers of the auxiliary DQ during the upset transient back to their corresponding processor system registers upon detection of said end.

45. The method of claim 40 wherein the data of the selected registers of the processor system transferred to the auxiliary DQ represent a state thereof at the onset of the upset transient.

46. The method of claim 40 including the steps of programming the registers of the auxiliary DQ with instruction sequences; and operating the auxiliary DQ to insert said programmed instruction sequences into an instruction execution stream of the processor system.

47. Auxiliary boot loader apparatus embedded in a processor system and operable in a power-up mode of said processor system, said apparatus comprising:
an auxiliary instruction queue (IQ) including a plurality of storage registers configurable in said power-up mode to store a set of boot loader instructions, said registers of the auxiliary IQ being accessible by the processor system; and
means for detecting said power-up mode and causing said processor system to access and execute the stored instructions of said auxiliary IQ.

48. The apparatus of claim 47 including a cache operable as a memory of the processor system during said power-up mode; and a communication interface; and wherein the processor system is operable to execute the boot loader instructions of the auxiliary IQ to cause a stream of instructions to be loaded into the cache from an external system through the communication interface.

49. The apparatus of claim 48 including means for causing the execution of the instructions loaded into the cache.

50. The apparatus of claim 47 wherein the auxiliary IQ is reconfigurable to another mode of operation.
